(19) United States
(12) Patent Application Publication
(10) Pub. No.: US 2021/0007280 A1
(43) Pub. Date: Jan. 14, 2021

(54) Transverse Conveyor of an Agricultural Harvesting Machine

(71) Applicant: CLAAS Saulgau GmbH, 88348 Bad Saulgau (DE)

(72) Inventor: Ulrich Boll, Bad Salgau (DE)

(21) Appl. No.: 16/923,875

(22) Filed: Jul. 8, 2020

(30) Foreign Application Priority Data
Jul. 10, 2019 (DE) 102019118740.0

(51) Int. Cl. A01D 57/20

(52) U.S. Cl. CPC A01D 57/20

(57) ABSTRACT

Transverse conveyor (12) of an agricultural harvesting machine, in order to convey harvested crop in a conveying direction running transversely with respect to the direction of movement of the harvesting machine, with a transverse conveyor belt (14), and with lateral deflecting pulleys (15, 16) on which the transverse conveyor belt (14) is guided, wherein each of the lateral deflecting pulleys (15, 16) is assigned a respective drive unit (17, 18), with the aid of which the transverse conveyor belt (14) is drivable.

The invention relates to a transverse conveyor of an agricultural harvesting machine according to the precharacterizing clause of claim 1.

Agricultural harvesting machines with transverse conveyors are well known in industry. The transverse conveyors can be designed here as screw conveyors or else as belt conveyors. The invention here relates to a transverse conveyor of an agricultural harvesting machine with a transverse conveyor belt which is thus designed as a belt conveyor. Such transverse conveyors designed as belt conveyors are used, for example, in mergers or pickup swathers or else in mower units.

In the case of transverse conveyors which are known in industry and which have a transverse conveyor belt which is guided on lateral deflecting pulleys, the correct driving of the transverse conveyor belt has caused difficulties to date. In particular in the case of relatively long transverse conveyor belts, that is in which the distance between the deflecting pulleys is relatively large, the correct driving of the transverse conveyor belt is a problem. There is therefore a need for a novel transverse conveyor which can be driven better.

Taking this as the starting point, the present invention is based on the object of providing a novel transverse conveyor of an agricultural harvesting machine.

This object is achieved by a transverse conveyor of an agricultural harvesting machine according to claim 1.

According to the invention, each of the lateral deflecting pulleys is assigned a respective drive unit, with the aid of which the transverse conveyor belt is drivable. According to the invention, it is therefore proposed that the two deflecting pulleys of the transverse conveyor are assigned a respective drive unit, with the aid of which the transverse conveyor belt can be driven.

The use of one drive unit per deflecting pulley has a multiplicity of advantages. Thus, good driving of the transverse conveyor belt can be provided in both possible transverse conveying directions. Sagging of what is referred to as a return strand can be prevented even without a corresponding tensioning device. Furthermore, a relatively small drive unit can be used in the region of each deflecting pulley, as a result of which advantages in terms of construction space and costs can be realized.

According to an advantageous development, a direction of rotation of the drive units is reversible. Correct driving of the transverse conveyor belt can thereby be ensured in both possible transverse conveying directions of the transverse conveyor.

According to an advantageous development, a first or upper strand of the transverse conveyor belt serves as a conveying strand and a second or lower strand of the transverse conveyor belt serves as a return strand, wherein, in both possible conveying directions of the transverse conveyor, both the conveying strand and the return strand are pulled by a first drive unit and pushed by a second drive unit. Both conveying strand and return strand can be correctly driven and tensioned in both conveying directions of the transverse conveyor or transverse conveyor belt.

According to an advantageous development, the respective drive unit has an electric motor and/or hydraulic motor. Electric motors and hydraulic motors are particularly suitable as drive units.

Preferred developments of the invention emerge from the dependent claims and the description below. Exemplary embodiments of the invention, without being limited thereto, will be explained in more detail with reference to the drawing, in which:

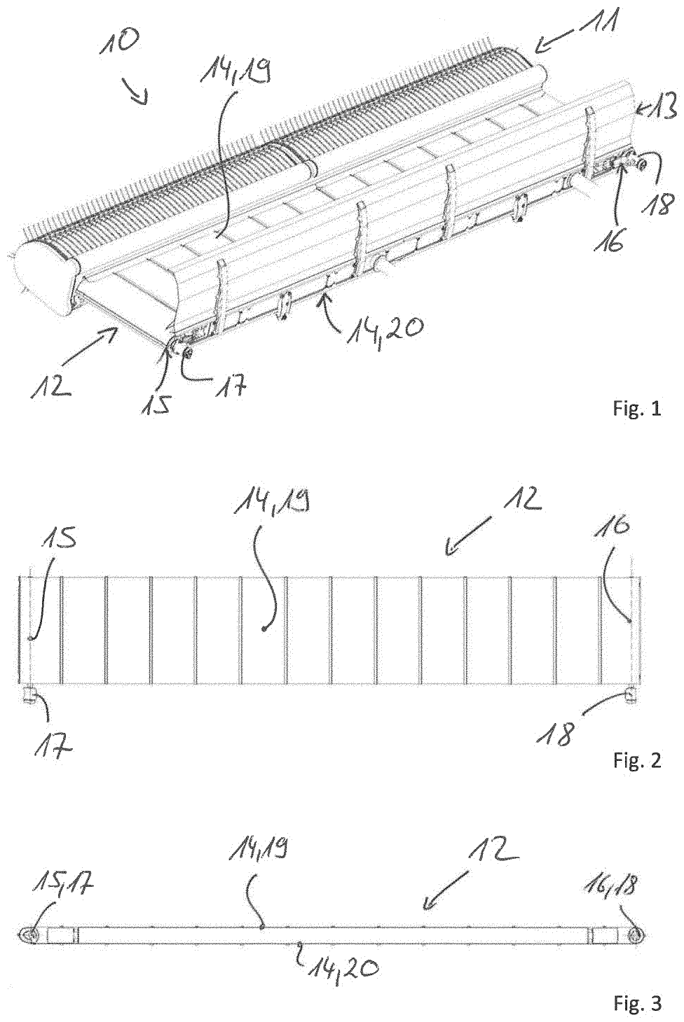

FIG. 1 shows a perspective rear view of a constructional unit consisting of a transverse conveyor according to the invention and a pickup member of an agricultural harvesting machine designed as a merger or pickup swather;

FIG. 2 shows the transverse conveyor according to the invention in a top view;

FIG. 3 shows the transverse conveyor according to the invention in a rear view.

FIG. 1 shows a constructional unit 10 consisting of a pickup member 11 and a transverse conveyor 12 of an agricultural harvesting machine, wherein the pickup member 11 is designed as what is referred to as a pickup and the transverse conveyor 12 as a belt conveyor. Such a constructional unit 10 is used in particular in a harvesting machine designed as a merger, wherein a merger is also referred to as a pickup swather. The pickup member 11 is arranged on a first longitudinal side of the transverse conveyor 12. A guide device 13 for the harvesting crop that is to be transported is arranged on an opposite second transverse side of the transverse conveyor 12.

The invention here relates to the configuration of the transverse conveyor 12 that is shown by itself in FIGS. 2 and 3. The transverse conveyor 12 serves for transporting harvested crop in a conveying direction running transversely with respect to the direction of movement of the harvesting machine.

The transverse conveyor 12 has a transverse conveyor belt 14 which is guided on two lateral deflecting pulleys 15, 16.

A first or upper strand of the transverse conveyor belt 14 in the respective state of the transverse conveyor belt 14 is also referred to as a conveying strand 19 and a second or lower strand of the transverse conveyor belt 14 is also referred to as a return strand 20.

During the transportation of harvested crop with the aid of the transverse conveyor 12, the transverse conveyor belt 14 is driven and guided on the deflecting pulleys 15, 16.

In the case of the transverse conveyor 12 according to the invention, it is provided that each of the two deflecting pulleys 15, 16 is assigned a respective drive unit 17, 18, with the aid of which the transverse conveyor belt 14 is drivable. Thus, the deflecting pulley 15 is assigned the drive unit 17 and the deflecting pulley 16 is assigned the drive unit 18. The two drive units 17, 18 are drive units, the direction of rotation of which is reversible.

In particular, the respective drive unit 17, 18 comprises an electric motor or else a hydraulic motor. However, other drive systems may also be used for driving the deflecting pulleys 15, 16 and therefore the transverse conveyor belt 14.

When a respective drive unit 17, 18 is present in the region of the two deflecting pulleys 15, 16 and when the direction of rotation of said drive units 17, 18 is reversible, in both possible conveying directions of the transverse conveyor 14 the respective conveying strand 19 and the respective return strand 20 are pulled by a first drive unit and pushed by a second drive unit. It can thereby be ensured that, in both conveying directions of the transverse conveyor 14, both the respective conveying strand 19 and the respective return strand 20 are tensioned and do not sag. Separate tensioning devices can thus be omitted. This is of advantage in particular if the distance between the two deflecting pulleys 15, 16 is relatively large and therefore the length of the transverse conveyor belt 14 is relatively long.

The invention permits an improved driving of a transverse conveyor 12 designed as a belt conveyor, i.e. of the transverse conveyor belt 14 of the transverse conveyor 12. The transverse conveyor belt 14 is guided on two lateral deflecting pulleys 15, 16. Each of said lateral deflecting pulleys 15, 16 is assigned a respective drive unit 17, 18. The direction of rotation of the drive units 17, 18 is reversible. Both conveying strand 19 and return strand 20 are pushed and pulled in both conveying directions of the transverse conveyor belt 14.

The transverse conveyor 12 according to the invention is used in particular in a merger or pickup swather or else in a mower unit.

The invention relates not only to the transverse conveyor 12, but also to an agricultural harvesting machine which has at least one such transverse conveyor 12. As already explained, the agricultural harvesting machine is preferably a merger or pickup swather or else a mower unit.

### LIST OF REFERENCE SIGNS

10 Constructional unit
11 Pickup member
12 Transverse conveyor
13 Guide device
14 Transverse conveyor belt
15 Deflecting pulley
16 Deflecting pulley
17 Drive unit
18 Drive unit
19 Conveying strand
20 Return strand

1. Transverse conveyor (12) of an agricultural harvesting machine, in order to convey harvested crop in a conveying direction running transversely with respect to the direction of movement of the harvesting machine,
with a transverse conveyor belt (14),
with lateral deflecting pulleys (15, 16) on which the transverse conveyor belt (14) is guided, characterized in that
each of the lateral deflecting pulleys (15, 16) is assigned a respective drive unit (17, 18), with the aid of which the transverse conveyor belt (14) is drivable.

2. A transverse conveyor according to claim 1, characterized in that a direction of rotation of the drive units (17, 18) is reversible.

3. A transverse conveyor according to claim 1, characterized in that a first or upper strand of the transverse conveyor belt (14) serves as a conveying strand (19) and a second or lower strand of the transverse conveyor belt (14) serves as a return strand (20), wherein, in both possible conveying directions of the transverse conveyor (14), both the conveying strand (19) and the return strand (20) are pulled by a first drive unit (17, 18) and pushed by a second drive unit (18, 17).

4. A transverse conveyor according to claim 1, characterized in that the respective drive unit (17, 18) has an electric motor.

5. A transverse conveyor according to claim 1, characterized in that the respective drive unit (17, 18) has a hydraulic motor.

6. An agricultural harvesting machine with at least one transverse conveyor (12) according to claim 1.

7. The agricultural harvesting machine according to claim 6, characterized in that said agricultural harvesting machine is a merger or pickup swather.

8. The agricultural harvesting machine according to claim 6, characterized in that said agricultural harvesting machine is a mower unit.
